(19) United States
(12) Patent Application Publication
(10) Pub. No.: US 2014/0346254 A1
(43) Pub. Date: Nov. 27, 2014

(54) FUEL INJECTOR FOR GASEOUS INJECTION

(71) Applicant: Caterpillar Inc., Peoria, IL (US)

(72) Inventors: Dana R. Coldren, Secor, IL (US); Alan R. Stockner, Metamora, IL (US); David T. Montgomery, Edelstein, IL (US)

(73) Assignee: Caterpillar Inc., Peoria, IL (US)

(21) Appl. No.: 14/453,646

(22) Filed: Aug. 7, 2014

(51) Int. Cl. F02M 67/10; F02M 67/14

(52) U.S. Cl. CPC F02M 67/10; F02M 67/14
USPC 239/408

(57) ABSTRACT

A fuel injector comprises a liquid fuel cavity and a gas fuel cavity disposed within an injector cavity housing a liquid needle valve stem and a gas needle valve stem, respectively. The gas needle valve stem includes a guide stem portion distal to the injector tip and a check proximal to the injector tip. A drain passage terminates in a drain annulus groove disposed in a guide cavity wall of a gas valve guide cavity. The gas valve guide cavity houses the guide stem portion defining a clearance between the guide cavity wall below the drain annulus groove and the guide stem portion. The liquid fuel from the drain passage flows to the gas needle valve stem and an inner surface of the gas fuel cavity, through the clearance. The liquid fuel drained through the clearance collects in a plurality of grooves on the check.

### TECHNICAL FIELD

The present disclosure relates generally to fuel injection. More specifically, the disclosure relates to a fuel injector for gaseous fuel injection.

### BACKGROUND

Internal combustion engines have been used to drive machines. The internal combustion engines have undergone improvements to become more powerful, more efficient, and/or produce fewer emissions. One way this may be achieved, is through improvement in the fuel qualities. Gaseous fuels, such as methane, hydrogen, natural gas, or blends of such fuels have also been introduced. As compared to liquid fuels, gaseous fuels may produce more favorable emissions during combustion. However, the gaseous fuels may not ignite as easily, or at the same rate as that of the liquid fuels, which may cause problems. Therefore, a dual fuel engine may be used in which a mixture of the liquid fuel such as, diesel fuel, and the gaseous fuel such as, natural gas, may be injected into a combustion chamber of the internal combustion engine. The diesel fuel may initiate combustion inside the combustion chamber of the dual fuel engine, and the gaseous fuel may thus be ignited.

The dual fuel engine may use a dual fuel injector. The dual fuel engines may be constrained by narrow bands of air-fuel ratios acceptable for a stable and efficient combustion. Also, owing to the lean-burn limit combustion, the dual fuel engines may face difficulty in balancing the tendencies for auto-ignition for combustion. Furthermore, during the lean burn combustion, the fuel combustion flames tend to extinguish in crevices provided in the combustion chamber of the dual fuel engine. This tendency of gaseous fuels may lead to poor flame propagation, incomplete combustion of fuel, and may also reduce efficiency of the dual fuel engine.

The present disclosure is directed towards one or more of the problems set forth above.

### SUMMARY OF THE DISCLOSURE

The present disclosure relates to a fuel injector for injecting a liquid fuel and a gaseous fuel. The fuel injector comprises an injector body with an injector tip, wherein the injector tip is positioned at the bottom of the injector body.

The present disclosure relates to a fuel injector comprising an injector cavity, a liquid needle valve, a gas needle valve, and a drain passage. The injector cavity comprising a liquid fuel cavity, a gas fuel cavity, a spring cavity, and a gas valve guide cavity. The gas fuel cavity is disposed offset from the liquid fuel cavity. The gas valve guide cavity is disposed between the spring cavity and the gas fuel cavity. The liquid needle valve stem comprises a liquid needle valve stem and a liquid needle valve spring. The gas needle valve stem comprises a gas needle valve stem and a gas needle valve spring. The gas needle valve stem includes a guide stem portion and a check. The guide stem portion of the gas needle valve stem is distal to the injector tip and is disposed in a gas valve guide cavity, while the check of the gas needle valve stem is proximal to the injector tip and is disposed in the gas fuel cavity. The check of the gas needle valve stem includes a plurality of grooves configured to collect liquid fuel.

According to the present disclosure, the drain passage is disposed in the injector body and terminates in the gas valve guide cavity. The gas valve guide cavity includes a guide cavity wall equipped with a drain annulus groove which is in fluid communication with the drain passage. The drain passage is configured to deliver the liquid fuel to the drain annulus groove. The drain annulus groove is configured to deliver the liquid fuel on the gas needle valve stem and an inner surface of the gas fuel cavity, via a clearance defined between the guide cavity wall below the drain annulus groove and the gas needle valve stem. The liquid fuel is drained through the clearance. The liquid fuel drained on the gas needle valve stem is collected in the plurality of grooves disposed on the check of the gas needle valve.

### BRIEF DESCRIPTION OF THE DRAWINGS

FIG. 1 illustrates a fuel injector, in accordance with the concepts of the present disclosure; and

FIG. 2 illustrates side view of the fuel injector, in accordance with the concepts of the present disclosure.

### DETAILED DESCRIPTION

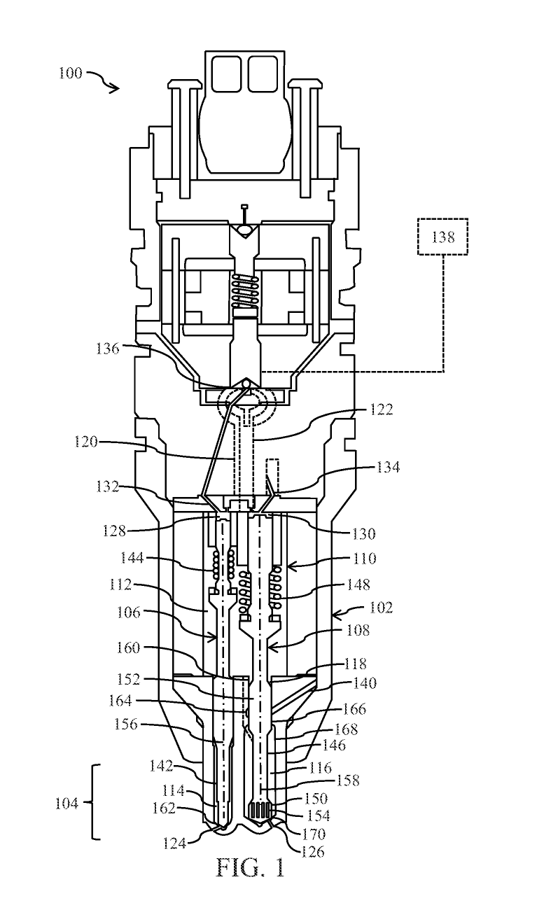

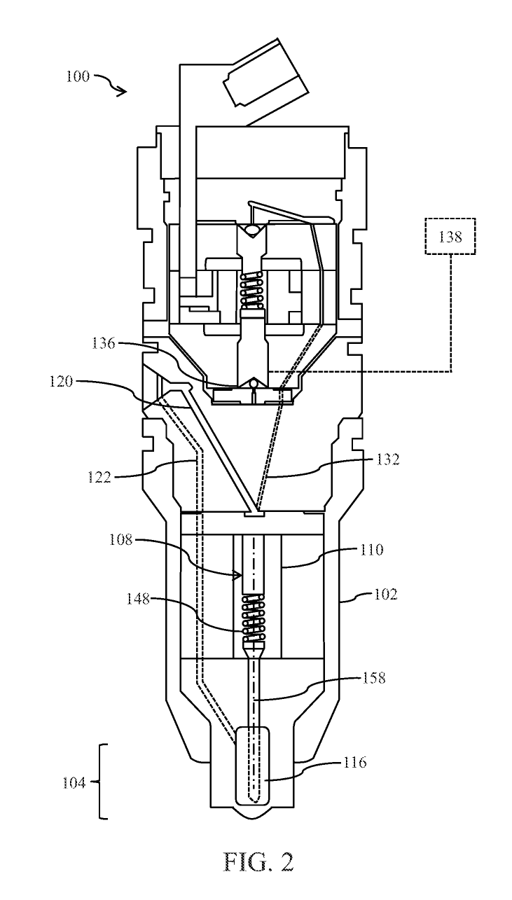

FIG. 1 illustrates a fuel injector 100, according to an aspect of the present disclosure. FIG. 2 illustrates side view of the fuel injector 100, according to an aspect of the present disclosure. In reference to FIG. 1 and FIG. 2, the fuel injector 100 may include an injector body 102 with an injector tip 104, a liquid needle valve 106, a gas needle valve 108, an injector cavity 110, a spring cavity 112, a liquid fuel cavity 114, a gas fuel cavity 116, a gas valve guide cavity 118, a liquid fuel supply line 120, a gas fuel supply line 122, a liquid nozzle outlet 124, a gas nozzle outlet 126, a liquid control chamber 128, a gas control chamber 130, a liquid drain line 132, a gas drain line 134, a control valve 136, an actuator 138, and a drain passage 140. The injector body 102 includes the injector tip 104. The injector body 102 may be configured to house the liquid needle valve 106 and the gas needle valve 108. The liquid needle valve 106 includes a liquid needle valve stem 142 and a liquid needle valve spring 144. The gas needle valve 108 includes a gas needle valve stem 146 and a gas needle valve spring 148. The gas needle valve stem 146 includes a check 150 and a guide stem portion 152. The check 150 of the gas needle valve stem 146 is proximal to the injector tip 104. The check 150 includes a plurality of grooves 154 which are configured to reserve or hold liquid fuel. The guide stem portion 152 of the gas needle valve stem 146 is distal to the injector tip 104.

Further, the injector body 102 defines the injector cavity 110. The injector cavity 110 includes the spring cavity 112, the liquid fuel cavity 114, the gas fuel cavity 116, and the gas valve guide cavity 118. The spring cavity 112 is configured to house the liquid needle valve spring 144 and the gas needle valve spring 148. The liquid fuel cavity 114 is disposed near the injector tip 104 and aligned along a first longitudinal axis 156. The liquid fuel cavity 114 is configured to house the liquid needle valve stem 142. The gas fuel cavity 116 is disposed near the injector tip 104 along a second longitudinal axis 158 and is offset from the liquid fuel cavity 114. The gas fuel cavity 116 is configured to house the check 150 of the gas needle valve stem 146. The guide stem portion 152 of the gas needle valve stem 146 is accommodated in the gas valve guide cavity 118. The gas valve guide cavity 118 is disposed between the spring cavity 112 and the gas fuel cavity 116 along the second longitudinal axis 158. The gas valve guide cavity 118 includes a guide cavity wall 160. The gas valve guide cavity 118 is configured to house the guide stem portion 152 of the gas needle valve stem 146.

The injector body 102 may be equipped with the liquid fuel supply line 120 to enable the intake of a liquid fuel (such as, diesel oil). The liquid fuel supply line 120 is configured to supply the liquid fuel to the liquid fuel cavity 114. Flow of the liquid fuel from the liquid fuel cavity 114 to the liquid nozzle outlet 124 is controlled by the liquid needle valve stem 142. The liquid nozzle outlet 124 may be disposed below the liquid fuel cavity 114 and in the injector tip 104.

Further, the liquid fuel supply line 120 may also be configured to supply the liquid fuel to the liquid control chamber 128 and the gas control chamber 130. The liquid control chamber 128 and the gas control chamber 130 are located within the injector cavity 110. The liquid control chamber 128 and the gas control chamber 130 may be in fluid communication with the liquid drain line 132 and the gas drain line 134, respectively. The liquid drain line 132 and the gas drain line 134 are configured to drain liquid fuel from the liquid control chamber 128 and the gas control chamber 130, respectively. Opening and closing of the liquid drain line 132 is controlled by the control valve 136 actuated by the actuator 138 which in turn is controlled by a controller (not shown). Similarly, the opening and closing of the gas drain line 134 is controlled by another control valve (not shown) actuated by another actuator (not shown). Drainage of liquid fuel through the liquid drain line 132 and the gas drain line 134 reduces the pressure in the liquid control chamber 128 and the gas control chamber 130, respectively. In other words, blocking and opening of the liquid drain line 132 and the gas drain line 134 controls vertical movement the liquid needle valve stem 142 and the gas needle valve stem 146, respectively.

The liquid needle valve stem 142 of the liquid needle valve 106 is movable along the first longitudinal axis 156. The liquid needle valve 106 moves between an open position and a closed position. As illustrated in FIG. 1, the closed position of the liquid needle valve 106 is shown. The liquid needle valve 106 attains the closed position by the pressurized liquid fuel in the spring cavity 112 and the liquid control chamber 128. Accumulation of the pressurized liquid fuel causes spring force to push the liquid needle valve stem 142 to the closed position. In the closed position, the liquid needle valve stem 142 of the liquid needle valve 106 is biased against a liquid needle valve seat 162 by action of the liquid needle valve spring 144. When the liquid needle valve 106 is in the closed position, the fluid communication is blocked between the liquid nozzle outlet 124 and the liquid fuel cavity 114.

When the liquid fuel is drained from the liquid control chamber 128 through the liquid drain line 132, the pressure in the liquid control chamber 128 reduces. Reduction in pressure in the liquid control chamber 128 lifts the liquid needle valve stem 142 to the open position against the biasing action of the liquid needle valve spring 144, thereby allowing injection of the liquid fuel into a combustion chamber of a cylinder.

The gas fuel supply line 122 may be disposed within the injector body 102. The gas fuel supply line 122 may be configured to allow intake of the gaseous fuel into the fuel injector 100 by supplying the gaseous fuel to the gas fuel cavity 116. In an embodiment of the present disclosure, the gaseous fuel can be natural gas, pure methane, butane, propane, hydrogen, and/or combinations of various hydrocarbons. The gaseous fuel entering through the gas fuel supply line 122 may be supplied to the gas fuel cavity 116.

As discussed above, the gas fuel cavity 116 accommodates the gas needle valve stem 146 which is movable along the second longitudinal axis 158. The gas needle valve stem 146 may be configured to control a flow of gaseous fuel from the gas fuel cavity 116 to the combustion chamber through the gas nozzle outlet 126. The gas needle valve stem 146 includes the guide stem portion 152 which is disposed in the gas valve guide cavity 118. The guide stem portion 152 is positioned in the gas valve guide cavity 118 in a way such that the guide stem portion 152 interacts with the guide cavity wall 160 to ensure proper sealing when the gas needle valve 108 moves between the open position and the closed position. The guide cavity wall 160 includes a drain annulus groove 164 in fluid communication with the drain passage 140. The drain passage 140 terminates in the drain annulus groove 164, thereby allowing the liquid fuel to flow to the drain annulus groove 164. The drain annulus groove 164 is configured to receive the liquid fuel drained by the drain passage 140.

A portion of the guide cavity wall 160 below the drain annulus groove 164 is referred to as a land portion 166. The land portion 166 along with the guide stem portion 152 of the gas needle valve stem 146 defines a clearance (not shown) therebetween. The clearance (not shown) is configured to control the flow of the liquid fuel from the drain annulus groove 164 to the gas fuel cavity 116 and the gas needle valve stem 146.

In the gas fuel cavity 116, the liquid fuel flowing through the clearance (not shown) is drained on an inner surface 168 of the gas fuel cavity 116 and the gas needle valve stem 146. In an embodiment, the gas fuel cavity 116 may include a plurality of slots or grooves (not shown) on the inner surface 168 of the gas fuel cavity 116. The plurality of slots or grooves (not shown) is configured to collect the liquid fuel supplied to the inner surface 168 of the gas fuel cavity 116 through the clearance (not shown). With further reference to FIG. 1, the liquid fuel drained on the gas needle valve stem 146 collects in the plurality of grooves 154 on the check 150. However, a person with ordinary skills in the art will appreciate that shape, size, and geometry of the plurality of grooves 154, does not limit the idea disclosed.

The gas needle valve 108 operates between a closed position and an open position. The closed position of the gas needle valve 108 is illustrated in FIG. 1. In reference to FIG. 1, in the closed position of the gas needle valve 108, the gas needle valve stem 146 is biased against a gas needle valve seat 170 by the gas needle valve spring 148 that may be located in the gas control chamber 130 within the injector cavity 110. The gas needle valve 108 is maintained in the closed position due to the pressure of the liquid fuel accumulated in the spring cavity 112 and the gas control chamber 130. The pressurized liquid fuel in the spring cavity 112 along with the spring force of the gas needle valve spring 148 pushes the gas needle valve stem 146 to the closed position. In the closed position of the gas needle valve 108, the gas needle valve stem 146 blocks the fluid communication between the gas fuel cavity 116 and the gas nozzle outlet 126.

When the liquid fuel is drained from the gas control chamber 130 by the gas drain line 134, the pressure in the gas control chamber 130 is reduced. Due to reduction in the pressure, the gas needle valve stem 146 lifts against biasing action of the gas needle valve spring 148 to attain the open position. In the open position of the gas needle valve 108, the gas needle valve stem 146 rises and moves apart from the gas needle valve seat 170 to allow the supply of a measured amount of gaseous fuel to the combustion chamber (not shown) of the cylinder through the gas nozzle outlet 126.

In operation, a liquid injection event may be controlled by the actuator 138 which actuates the control valve 136. The control valve 136 may be in a position to block to the liquid drain line 132. The blocking of the liquid drain line 132 allows the liquid fuel to remain inside the liquid control chamber 128 and the liquid fuel cavity 114. This results in a build-up of pressure inside the liquid control chamber 128 and the liquid fuel cavity 114. The pressurized liquid fuel, along with the liquid needle valve spring 144, urges the liquid needle valve stem 142 to be maintained in the closed position, as shown in FIG. 1.

When the liquid fuel cavity 114 is charged with the liquid fuel, the actuator 138 actuates the control valve 136 to unblock the liquid drain line 132 such that the liquid fuel is drained from the liquid control chamber 128. When this is done, the pressure inside the liquid control chamber 128 drops allowing the liquid needle valve stem 142 of the liquid needle valve 106 to lift against the action of the biasing liquid needle valve spring 144 to attain the open position. The open position of the liquid needle valve 106 allows the liquid fuel in the liquid fuel cavity 114 to inject into the combustion chamber through the liquid nozzle outlet 124.

Similarly, a gas injection event may be controlled by the control valve 136 actuated by the actuator 138. The control valve 136 may be in a position to block the gas drain line 134. The blocking of the gas drain line 134 allows the liquid fuel to remain inside the gas control chamber 130. This results in a build-up of pressure inside the gas control chamber 130, thus maintaining the gas needle valve stem 146 in closed position, as shown in FIG. 1. While the pressurized liquid fuel along with the gas needle valve spring 148, maintains the gas needle valve 108 in the closed position, the gas fuel supply line 122 supplies the gaseous fuel into the gas fuel cavity 116. When the gas needle valve 108 is in the closed position, a measured amount of the high-pressure liquid fuel is supplied from the liquid fuel drain circuit (not shown) to the drain annulus groove 164 through the drain passage 140. The liquid fuel thus supplied is drained through the clearance (not shown) between the guide stem portion 152 of the gas needle valve stem 146 and the land portion 166. The liquid fuel which enters through the clearance (not shown) is drained on the gas needle valve stem 146 and the inner surface 168 of the gas fuel cavity 116. The liquid fuel drained on the gas needle valve stem 146 is collected in the plurality of grooves 154 on the check 150.

Prior to gas injection, the gas fuel cavity 116 is charged with the gaseous fuel and the liquid fuel is collected in the plurality of grooves 154 on the check 150 of the gas needle valve stem 146. For gas injection event, the control valve 136 is actuated to unblock the gas drain line 134 such that the liquid fuel is drained from the gas control chamber 130. At this point, the pressure in the gas control chamber 130 drops. Decrease in the pressure of the liquid fuel in the gas control chamber 130 allows the gas needle valve stem 146 to lift to the open position. The open position of the gas needle valve stem 146 of the gas needle valve 108 allows for fluid communication between the gas fuel cavity 116 and the gas nozzle outlet 126. Thus, the pressurized gaseous fuel along with the high-pressure liquid fuel is injected in the combustion chamber through the gas nozzle outlet 126. In an embodiment the high-pressure liquid fuel may also be injected through the drain passage 140 during the gaseous injection event when the gas needle valve 108 is in the open position.

### INDUSTRIAL APPLICABILITY

In operation, the disclosed fuel injector 100 injects the liquid fuel and the gaseous fuel in the combustion chamber of the cylinder. The disclosed fuel injector 100 is configured to inject liquid fuel prior to gas injection event and also, during the gas injection event.

Prior to the gas injection event, when the control valve 136 is in the position to block the gas drain line 134. The blocking of the gas drain line 134 allows the liquid fuel to remain inside the gas control chamber 130. This results in a build-up of pressure inside the gas control chamber 130, thus maintaining the gas needle valve stem 146 in the closed position. The gaseous fuel is supplied to the gas fuel cavity 116, leading to rise in pressure in the gas fuel cavity 116. Further, a measured quantity of the pressurized liquid fuel is delivered to the drain annulus groove 164 by the drain passage 140. The liquid fuel from the drain annulus groove 164 is drained onto the gas needle valve stem 146 and the inner surface 168 of the gas fuel cavity 116 through the clearance (not shown) between the guide stem portion 152 of the gas needle valve stem 146 and the land portion 166. The liquid fuel drained onto the gas needle valve stem 146 is collected in the plurality of grooves 154 on the check 150. In an embodiment, the plurality of grooves 154 may be disposed or machined on the inner surface 168 of the gas fuel cavity 116. As the control valve 136 is actuated to unblock the gas drain line 134, the liquid fuel of the gas control chamber 130 flows through the gas drain line 134. This reduces the pressure in the gas control chamber 130 allowing the gas needle valve stem 146 to lift to the open position. This allows the gaseous fuel in the gas fuel cavity 116, along with the liquid fuel collected in the plurality of grooves 154, to inject into the combustion chamber through the gas nozzle outlet 126.

In an alternative embodiment, the plurality of grooves 154 in the fuel injector 100, which hold the liquid fuel, facilitates mixing of the gaseous fuel and the liquid fuel prior to and during the gas injection event. Hence, the proposed design of the fuel injector 100 facilitates the pre-mixing of liquid fuel in the gaseous fuel injection. The plurality of grooves 154 in the fuel injector 100, which hold the liquid fuel, facilitates mixing of the gaseous fuel and the liquid fuel prior to and during the gas injection event. Upon ignition, addition of liquid fuel (such as, diesel) helps to attain complete and efficient combustion. Also, injection of pre-mixed gaseous fuel at high pressures may lead to expansion of the gaseous fuel and thereby may cause a cooling effect.

The present description is for illustrative purposes only and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claim.

What is claimed is:

1. A fuel injector for gaseous injection having an injector body with an injector, wherein the injector tip is positioned at bottom of the fuel injector, the fuel injector comprising:
a liquid needle valve comprising a liquid needle valve stem and a liquid needle valve spring;
a gas needle valve comprising a gas needle valve stem and a gas needle valve spring, wherein the gas needle valve stem including:
a guide stem portion distal to the injector tip; and
a check proximal to the injector tip;
an injector cavity disposed in the injector body, the injector cavity including:
a spring cavity configured to house the liquid needle valve spring and the gas needle valve spring;
a liquid fuel cavity disposed near the injector tip and along a first longitudinal axis, the liquid fuel cavity configured to house the liquid needle valve stem;
a gas fuel cavity disposed near the injector tip and along a second longitudinal axis in the injector body, the gas fuel cavity configured to house the gas needle valve stem, wherein the gas fuel cavity is offset from the liquid fuel cavity; and
a gas valve guide cavity disposed between the spring cavity and the gas fuel cavity, the gas valve guide cavity configured to house the guide stem portion of the gas needle valve stem, wherein the gas valve guide cavity comprising a guide cavity wall;
a drain passage disposed within the injector body and terminates in a drain annulus groove disposed in the guide cavity wall of the gas valve guide cavity, the drain passage configured to allow flow of the liquid fuel to the drain annulus groove, wherein the drain annulus groove is configured to drain the liquid fuel on the gas needle valve stem and an inner surface of the gas fuel cavity through a clearance defined between the guide cavity wall below the drain annulus groove and the guide stem portion; and
a plurality of grooves disposed on the check of the gas needle valve stem, wherein the plurality of grooves are configured to collect the liquid fuel drained on the gas needle valve stem through the clearance.
